(19) United States
(12) Patent Application Publication
(10) Pub. No.: US 2025/0086528 A1
(43) Pub. Date: Mar. 13, 2025

(54) COMMISSIONING OF MONITORING RESOURCES

(71) Applicant: Honeywell International Inc., Charlotte, NC (US)

(72) Inventors: Sachin Kulkarni, Bengaluru (IN); Sarath Kumar Ganesan, Bengaluru (IN); Kartikeyan Bollapalli, Bengaluru (IN)

(21) Appl. No.: 18/780,498

(22) Filed: Jul. 23, 2024

Related U.S. Application Data
(60) Provisional application No. 63/537,846, filed on Sep. 12, 2023.

(51) Int. Cl. G06Q 10/063; G06K 7/14; G06Q 10/083

(52) U.S. Cl. CPC G06Q 10/063; G06K 7/1404; G06Q 10/083

(57) ABSTRACT

Techniques for commissioning of monitoring resources are disclosed. A transportable unit identifier (TUI) for each of a plurality of transportable units is determined. Each of the transportable units has a set of discrete transportable units associated therewith. A discrete unit identifier (DUI) linked with the set of discrete transportable units of each of the transportable units is then retrieved. A set of condition parameters, required to be monitored for the set of discrete transportable units, is determined for each DUI. One or more transportable units having the set of discrete transportable units requiring monitoring of analogous set of condition parameters are identified. Further, a cluster recommendation signal is generated to trigger rendering of a recommendation to cluster the one or more transportable units. A resource commissioning signal is also generated to trigger rendering of a recommendation to commission at least one monitoring resource for the one or more transportable units.

### BACKGROUND

Supply chain management plays a vital role in managing the flow of goods. For instance, in a commerce industry, supply chain management may be implemented across multiple milestones or stages, including procurement of raw materials to transportation of final articles to their respective destination. In many cases, multiple articles are packed together and shipped, for example, from a manufacturing site or warehouse to a delivery location. During transit, ensuring the quality and safety of the articles, or the packages, may be of high importance, specifically in the case of perishable and/or sensitive articles. To ensure safety and quality, in one example, conditions to which the articles or packages are exposed are monitored. To monitor the conditions, for example, multiple sensors are generally deployed for the packages or articles.

### BRIEF DESCRIPTION OF DRAWINGS

The detailed description is described with reference to the accompanying figures. It should be noted that the description and figures are merely examples of the present subject matter and are not meant to represent the subject matter itself.

FIGS. 1A and 11B illustrate a block diagram of a computing environment, according to an example implementation of the present subject matter.

FIG. 2 illustrates a block diagram of a system, according to one example implementation of the present subject matter.

FIG. 3 illustrates a block diagram of a computing environment comprising the system, according to another example implementation of the present subject matter.

FIG. 4A illustrates a mapping indicating an interlink between a transportable unit identifier corresponding to each of transportable units and a discrete unit identifier linked with a set of discrete transportable units of each of the transportable units, according to one example implementation of the present subject matter.

FIG. 4B illustrates a mapping between each of the set of discrete transportable units and their corresponding set of condition parameters, according to one example implementation of the present subject matter.

FIG. 4C illustrates a combined mapping between the transportable unit identifiers, discrete unit identifiers, and the set of condition parameters, according to one example implementation of the present subject matter.

FIGS. 5A and 5B illustrate an exemplary method for commissioning of monitoring resources and generation of an alert, according to one example implementation of the present subject matter.

FIG. 6 illustrates a non-transitory computer-readable medium for commissioning a monitoring resource for transportable units, in accordance with an example of the present subject matter.

FIG. 7 illustrates a hierarchy of identifier codes, according to one example implementation of the present subject matter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Ensuring the intended transportation of articles or packages is of high importance in supply chain management. For example, conditions being experienced by the articles or packages are required to be actively monitored to ensure their safety and quality, specifically for sensitive, perishable, and high-value articles. The conditions may be related to, for example, environmental conditions, storage conditions, and other conditions associated with safety and handling. In certain cases, changes in the conditions may have an unintended and detrimental effect on the articles or packages, rendering them less valuable, unacceptable, or unusable. Thus, monitoring the conditions to which the articles or packages are exposed is necessary to ensure that the articles or packages remain in acceptable and usable conditions, for instance, between different logistic milestones. Monitoring of the conditions experienced by the articles or packages is also necessary to preempt or avoid any possible damage and reduce product recalls.

With advancements in technology, various solutions have been developed to perform such monitoring. For instance, multiple sensors are generally deployed for monitoring one or more conditions experienced by the articles or packages between different logistic milestones. The sensors may be, for example, Internet of Things (IoT) enabled sensors, Cargo smart locks, and vehicle plugs. The sensors may have built-in capabilities, such as Wi-Fi, Narrowband, Lora, and Bluetooth. The sensors may monitor different conditions to which the articles or packages may be subjected, for example, while being transported. In one example, in case the packages being transported in a consignment are pallets containing certain drugs, the pallets may be required to be maintained within a desired temperature range so that the drugs are not affected over the course of transportation. The sensors, for instance, temperature sensors, provide information or indications regarding the temperature to which the drugs are being exposed.

Generally, deployment or commissioning of the sensors is manually strategized by considering several factors. Such factors may be, for example, the number of articles or packages, their size and type, and conditions required to be monitored. However, manually strategizing deployment or commissioning of the sensors is complex and challenging, especially for logistic personnel. The complexity and challenges increase in the size and number of articles or packages. Further, the challenges and complexities aggravate when different sensors are required to be deployed for monitoring different conditions based on varying types or characteristics of the articles or packages. Considering the above factors, the personnel may have to manually apply permutations and combinations to strategize the deployment or commissioning of multiple sensors.

Considering the example of the consignment containing drug pallets, the consignment may include heterogeneous drugs. Each kind of drug may require consideration of different monitoring conditions. Therefore, the personnel will have to consider multiple conditions required to be monitored for each type of drug in each of the pallets, and the granularity to which the monitoring should be performed. Further, the personnel is required to determine the number and position of the sensors that are required to be deployed for the consignment to monitor the required conditions. In such a scenario, multiple sensors are deployed within the consignment to constantly monitor the required conditions to ensure the safety and quality of the drugs.

The personnel has to spend a considerable amount of time to understand the condition requirements of the articles in packages, for example, drugs in the pallets, and accordingly commission each package with one or more sensors to analyze the required conditions. For example, the personnel needs to understand the nature of the packages or the articles to make optimal deployment and utilization of the sensors. However, as the process is manually performed, there are always chances of human errors in the deployment of the required sensors. It may also be possible that the personnel may deploy wrong sensors for the packages, thereby causing a failure in monitoring the required conditions. Thus, in such a scenario, the personnel may end up making incorrect determinations of the conditions required to be monitored for different articles or packages. As a result, the safety and quality of the articles may be compromised. Therefore, the efficiency and effectiveness of the manual process may be significantly dependent on the skills and judgments of the personnel.

Further, since each package is generally commissioned with at least one sensor, more number of sensors may be procured and deployed even when multiple packages may require monitoring of similar, or the same, conditions. Such a solution leads to over-deployment of sensors, thereby increasing the number of required sensors, and eventually resulting in increased operational costs. Also, as the sensors generate data, indicating the conditions being experienced by the articles or packages, the amount of data would increase with the increase in the number of sensors. Also, an increased amount of data may impact resource consumption and increase processing loads. For example, as the data may be communicated to external devices, such as to computing devices, for processing, large amounts of data would lead to increased network traffic and congestion, and increased resource consumption, for instance, bandwidth consumption. Also, as the data would be processed for monitoring purposes and to derive other desired outcomes, the processing load on computing resources would eventually increase, thereby affecting their processing capabilities, for example, processing speed. As a result, inefficiencies are introduced in the overall process of supply chain management.

Therefore, the conventional techniques are inefficient in deployment of sensors and monitoring the required conditions, thereby increasing the chances of rendering the articles damaged, unusable, or less valuable, along with increased operational costs and resource consumption.

The present subject matter relates to techniques for efficient commissioning of monitoring resources. In one example, the monitoring resources may be commissioned for monitoring conditions experienced by the articles, or packages comprising a set of articles between different logistic milestones, such as during their transit.

In one example, a package may include one or more articles associated therewith. For example, the one or more articles may either be located within the package or may be attached to the package. The package, hereinafter, may interchangeably and individually be referred to as a transportable unit, and the one or more articles may interchangeably be referred to as a set of discrete transportable units. The set may be a singleton set, in one example, having a single article or discrete transportable unit. In another example, the set may be a non-singleton set having multiple articles or discrete transportable units. Further, packages, hereinafter, may interchangeably and collectively be referred to as transportable units.

Thus, each of the transportable units may have a set of discrete transportable units associated therewith. In one example, the transportable units and the set of discrete transportable units associated therewith may have a hierarchical relationship therebetween. For example, the transportable units may include a first category of transportable units and a second category of transportable units, where each of the second category of transportable units is the discrete transportable unit located within the first category of transportable units.

Further, in one example, each of the transportable units may have a hierarchy of identifier codes. For example, the hierarchy may include a first level code and a second level code, where the first level code includes the transportable unit identifier uniquely identifying the transportable unit, and the second level code includes the discrete unit identifier linked with the set of discrete transportable units. In one example, the transportable unit identifier may be a Serial Shipping Container Code (SSCC) that may uniquely identify the transportable unit and the discrete unit identifier may be a Serialized Global Trade Identification Number (SGTIN) that may uniquely identify the set of discrete transportable unit. In one example, the transportable unit identifier and the discrete unit identifier may comply with global standards, such as GS1 standards.

According to one example, each of the transportable units may have a unique machine-readable code associated therewith. In one example, the machine-readable code may be a barcode. In response to scanning of the machine-readable code associated with each of the transportable units, a transportable unit identifier may be determined. The transportable unit identifier may uniquely identify each of the plurality of transportable units.

Further, for each transportable unit identifier, a discrete unit identifier linked with the set of discrete transportable units of each of the transportable units may be retrieved. In one example, the discrete unit identifier linked with the set of discrete transportable units may be retrieved from a data storage unit. The data storage unit may store, for example, a mapping indicating an interlink between the transportable unit identifier, corresponding to each of the transportable units, and the discrete unit identifier, linked with the set of discrete transportable units of each of the transportable units. Thus, for each transportable unit identifier, the discrete unit identifier linked with the transportable unit identifier and with the set of discrete transportable units may be retrieved. By retrieving the discrete unit identifier corresponding to the transportable unit identifier, it may be ascertained, for instance, which sets of discrete transportable units are located within the transportable unit. That is, the retrieval may enable the determination of which specific set of discrete transportable units is contained within the transportable unit identified by its associated identifier. For instance, for a transportable unit identifier, a discrete unit identifier may be retrieved that may be linked with the transportable unit identifier and, also, with the set of discrete transportable units. That is, based on the transportable unit identifier, the discrete unit identifier may be retrieved, where the discrete unit identifier is also linked with the set of discrete transportable units.

Further, for each retrieved discrete unit identifier, a set of condition parameters may be determined that are required to be monitored for the set of discrete transportable units. In one example, each discrete unit identifier may have associated therewith the set of condition parameters that are required to be monitored for the set of discrete transportable units. The set of condition parameters may include parameters, for example, that may ensure that the set of discrete transportable units maintains desired characteristics that may not hinder with safety, quality, and usability of the set of discrete transportable units. Examples of the set of condition parameters may include, but are not limited to, temperature, pressure, humidity, and vibration levels. In one example, the data storage unit may store a mapping that may indicate a link between the set of condition parameters and the discrete unit identifiers. Thus, the set of condition parameters required to be monitored for the set of discrete transportable units may be determined.

One or more transportable units, from amongst the plurality of transportable units, may then be identified. In one example, the one or more transportable units may be the transportable units that have the set of discrete transportable units which require monitoring of similar or analogous set of condition parameters. For example, based on the set of condition parameters, the set of discrete transportable units that require monitoring of same set of condition parameters may be identified. Since each set of discrete transportable units is associated with a corresponding transportable unit, the transportable units having the set of discrete transportable units, which require monitoring of similar set of condition parameters, may be identified.

Once the one or more transportable units have been identified, a cluster recommendation signal may then be generated to trigger rendering of a recommendation. The recommendation may indicate to cluster the identified one or more transportable units. In one example, the recommendation may indicate the transportable unit identifier associated with each of the one or more transportable units being recommended to be clustered. Further, a resource commissioning signal may also be triggered to cause rendering of another recommendation. In one example, the other recommendation may indicate commissioning of at least one monitoring resource for the identified one or more transportable units being recommended to be clustered. The at least one monitoring resource may monitor the set of condition parameters for the identified one or more transportable units. In one example, the at least one monitoring resource may be a sensor that may be commissioned for the identified one or more transportable units for monitoring the set of condition parameters.

The present subject matter addresses the problems associated with conventional techniques. For example, the transportable units having the set of discrete transportable units that require monitoring of the same, or largely similar, set of condition parameters are identified and recommended to be grouped or clustered. Thus, the transportable units requiring monitoring of same or similar set of condition parameters may be brought together, making handling of such packages more convenient as compared to such transportable units being spread across, for instance, different sections of a warehouse. For example, for packages that require a particular range of temperature to be maintained, clustering such packages in a section of the warehouse may efficiently enable maintaining the temperature range in that section of the warehouse, instead of requiring maintenance of the same temperature range in different sections if the packages were spread or located across different sections of the warehouse. In other words, it is more efficient and convenient to control the temperature in one section of the warehouse rather than in multiple sections.

Further, as the same, or similar, set of condition parameters are required to be monitored, one or more monitoring resources may accordingly be commissioned for the cluster of transportable units. Since the monitoring resources may be commissioned on a per cluster basis, instead of being commissioned separately for each transportable unit, a reduced number of monitoring resources may accordingly be required for deployment. Therefore, over-deployment of the monitoring resources may be eliminated, or at least considerably reduced. As a result, the overall operational cost is reduced.

Additionally, with the reduced number of monitoring resources, resource consumption may be considerably reduced. For example, with a reduced number of monitoring resources, a reduced amount of data may be generated for monitoring the similar, or same, number of transportable units. As a result, resource consumption and processing loads may be considerably reduced. Therefore, the present subject matter relates to techniques for recommending efficient commissioning of monitoring resources with improved overall process of supply chain management.

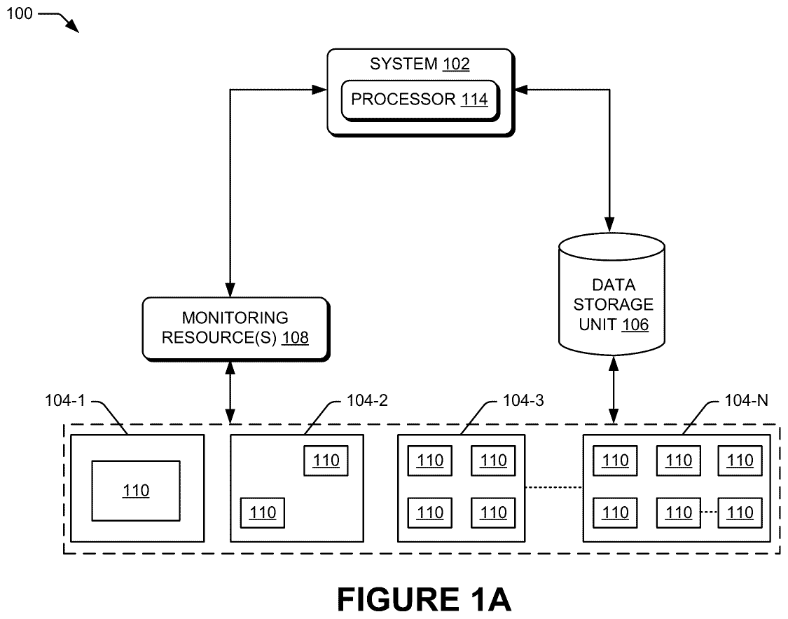

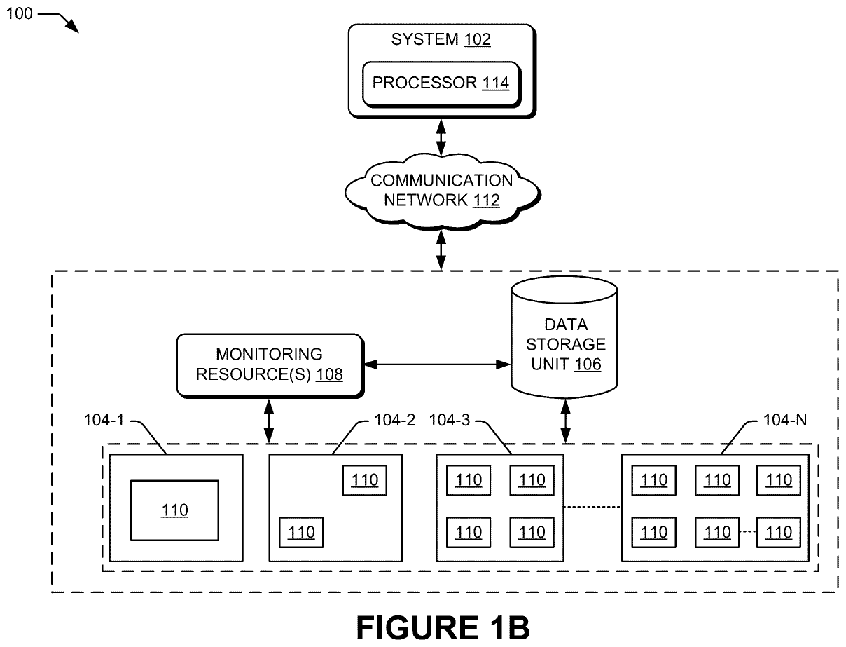

The above techniques are further described with reference to FIGS. 1A to 7. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIGS. 1A and 1B illustrate a block diagram of a computing environment 100, according to an example implementation. FIGS. 1A to 1B may be discussed in conjunction with each other. In one example, the computing environment 100 may be any environment having a system 102, transportable units 104, a data storage unit 106, and monitoring resource(s) 108.

In one example the computing environment 100 may be an environment associated with supply chain management. For example, the computing environment 100 may be related to acquiring, storing, and transporting packages, packages with one or more articles therein, services, and related information from a point of origin to a point of consumption. In another example, the computing environment 100 may be related to the storage and/or maintenance of packages and/or one or more articles therein. In yet another example, the computing environment 100 may be related to inventory management for tracking and managing inventory of packages and/or one or more articles. In yet another example, the computing environment 100 may be related to monitoring conditions experienced by the articles, or packages comprising a set of articles between different logistic milestones, such as during storage or their transit.

In one example, the computing environment 100 may include the transportable units 104. For example, as illustrated in FIGS. 1A and 1B, the computing environment 100 may include transportable units 104-1, 104-2, 104-3, . . . 104-N, where N is a natural number. The transportable units 104-1, 104-2, 104-3 . . . 104-N may, hereinafter individually be referred to as transportable unit 104 and collectively be referred to as transportable units 104. In one example, the transportable unit 104 may be an entity or a set of entities, that may be capable of being associated with one or more discrete transportable units 110. For example, the transportable units 104 may be entities that may be capable of receiving, storing, containing, or having attached thereto, the one or more discrete transportable units 110. Examples of the transportable units 104 may include, but are not limited to, packages, shipping containers, consignments, cases, containers, jars, boxes, pallets, bags, envelopes, wrappers, canisters, drums, vessels, storage racks, and cartons.

In one example, each of the transportable units 104 may have associated therewith a machine-readable code. The machine-readable code may be a machine-readable representation of data, numerals, and/or characters. Thus, the machine-readable code may be indicative of data, numerals, and/or characters associated with a transportable unit. The machine-readable representation, i.e., data, numerals, and/or characters, may form or indicate a transportable unit identifier that may uniquely identify the transportable units 104 with which it may be associated. That is, the transportable unit identifier may be indicated by the machine-readable representation determined from the machine-readable code associated with the transportable unit 104. In one example, it may also be possible that the machine-readable code may itself be the transportable unit identifier. In one example, the transportable unit identifier may be a Serial Shipping Container Code (SSCC) that may uniquely identify the transportable unit 104.

In one example, the machine-readable code may be a barcode. For example, the machine-readable code may be a 1-dimensional barcode or a 2-dimensional barcode. In one example, a unique machine-readable code may be associated or attached to each of the transportable units 104. For example, the machine-readable code may be printed on the transportable units 104 or may be attached as a tag or a label.

In one example, each of the transportable units 104 may be associated with one or more articles or products, being referred to as the discrete transportable units 110. For example, the one or more discrete transportable units 110 may be placed or located within the transportable units 104 or may be attached to the transportable units 104. The one or more discrete transportable units 110 may be associated with the transportable units 104 at any logistic stage or milestone in the supply chain. In one example, the one or more discrete transportable units 110 may be placed in the transportable units 104 at the time of packing or assembly.

The one or more discrete transportable units 110 may interchangeably be referred to as the set of discrete transportable units 110. The set, in one example, may be a singleton set having a single article or discrete transportable unit 110. For example, as illustrated in FIGS. 1A and 1B, the transportable unit 104-1 may include one discrete transportable unit 110. In another example, the set may be a non-singleton set having multiple articles or discrete transportable units 110. For example, as illustrated in FIGS. 1A and 1B, the transportable unit 104-2 may include two discrete transportable units 110, the transportable unit 104-3 may include four discrete transportable units 110, and the transportable unit 104-N may include M (not shown in Figures) discrete transportable units 110, where M is a natural number. Thus, a set of discrete transportable units 110 may include one or more discrete transportable units 110. Examples of the discrete transportable units 110 may include, but are not limited to, drugs, packed food items, cooking essentials, chemicals, fuels, products, electronic gadgets and components, perishable and non-perishable items, documents, and commodities. For example, the set of discrete transportable units 110 may be a strip comprising one or more tablets or pills. In another example, the set of discrete transportable units 110 may include two or more such strips.

In one example, each of the set of discrete transportable units 110 may have a discrete unit identifier linked therewith. In one example, the discrete unit identifier may be obtained from a machine-readable code that may be associated with each of the set of discrete transportable units 110. The machine-readable code, in one example, may be a barcode and may be a machine-readable representation of data, numerals, and/or characters. Thus, the machine-readable code may be indicative of data, numerals, and/or characters associated with the set of discrete transportable units 110. The machine-readable representation may form or indicate the discrete unit identifier that may uniquely identify the set of discrete transportable units 110. That is, the discrete transportable unit identifier may be indicated by the machine-readable representation determined from the machine-readable code associated with the set of discrete transportable units 110. In one example, it may also be possible that the machine-readable code may itself be the discrete transportable unit identifier. In one example, the discrete transportable unit identifier may be a Serialized Global Trade Identification Number (SGTIN) that may uniquely identify the set of discrete transportable units 110. The machine-readable code may be, for example, printed on the set of discrete transportable units 110 or may be attached as a tag or a label.

Thus, each of the transportable units 104 may have a set of discrete transportable units 110 associated therewith. In one example, the transportable units 104 and the set of discrete transportable units 110 associated therewith may have a hierarchical relationship therebetween. For example, the transportable units 104 may include a first category of transportable units and a second category of transportable units, where each of the second category of transportable units is the set of discrete transportable units 110 located within the first category of transportable units 104. Further, in one example, each of the transportable units 104 may have a hierarchy of identifier codes. For example, the hierarchy may include a first level code and a second level code, where the first level code includes the transportable unit identifier uniquely identifying the transportable units 104, and the second level code includes the discrete unit identifier linked with the set of discrete transportable units 110. In one example, the transportable unit identifier and the discrete unit identifier may comply with global standards, such as GS1 standards.

Further, in one example, the set of discrete transportable units 110 may require monitoring one or more condition parameters, hereinafter referred to as a set of condition parameters, to avoid any unintended and detrimental effect that may cause any damage, unintended change in their property or characteristic, or render them less valuable, unacceptable, or unusable. Examples of the set of condition parameters may include, but are not limited to, temperature, pressure, vibration level, humidity, or a combination thereof.

The computing environment 100 may further include the monitoring resource(s) 108. A plurality of monitoring resource(s) may be referred to as monitoring resources 108, whereas a single monitoring resource may be referred to as a monitoring resource 108. In one example, the monitoring resources 108 may be sensors. The sensors may be analog sensors or digital sensors. Examples of sensors may include, but are not limited to, temperature sensors, humidity sensors, proximity sensors, accelerometers, position sensors, load cells, motion sensors, level sensors, force sensors, light sensors, gyroscopes, image sensors, and touch sensors. In one example, the monitoring resources 108 may have built-in communication capabilities. For example, the monitoring resources 108 may have the capability to communicate and exchange data and/or signals using Wi-Fi, Narrowband, Lora, or Bluetooth. The monitoring resources 108 may be, in one example, IoT-enabled sensors. In one example, the monitoring resources 108 may be commissioned or deployed for monitoring a set of conditions being experienced by at least one of the transportable units 104 and the set of discrete transportable units 110, as will be discussed.

The computing environment 100 may further include the data storage unit 106. The data storage unit 106 may be any repository or storage unit implemented by physical, logical, and/or virtual storage devices. In one example, the data storage unit 106 may include a set of physical storage devices. In another example, the data storage unit 106 may include virtual stage devices being implemented on physical storage devices. In yet another example, the data storage unit 106 may include one or more physical or logical storage units that may either be located at the same location or distributed geographically. The data storage unit 106 may store information or data being exchanged or utilized in the computing environment 100. For example, the data storage unit 106 may store the transportable unit identifiers, the discrete unit identifiers, the set of condition parameters associated with each of the set of discrete unit identifiers, and data/signals generated by the monitoring resources 108, as will be discussed.

In one example, the computing environment 100 may include the system 102 communicably coupled with the data storage unit 106 and the monitoring resources 108. In one example, the system 102 may be in direct communication with the data storage unit 106 and the monitoring resources 108, as illustrated in FIG. 1A. In another example, the system 102 may be communicably coupled with the data storage unit 106 and the monitoring resources 108 over a communication network 112, as illustrated in FIG. 1B, to enable or assist inter-communications and exchange of data and signals. Examples of the communication network 112 may include, but are not limited to Local Area Network (LAN), Wire Area Network (WAN), internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 112 may include various network entities, such as transceivers, gateways, and routers. In one example, the communication network 112 may include any communication network that uses any of the commonly used protocols, for example, Hypertext Transfer Protocol (HTTP), and Transmission Control Protocol/Internet Protocol (TCP/IP).

In one example, the system 102 may include a processor 114. The processor 114 may be implemented as a dedicated processor, a shared processor, or a plurality of individual processors, some of which may be shared. Examples of the processor 114 may include, but are not limited to, microprocessors, microcomputers, microcontrollers, digital signal processors, central processing units, state machines, Artificial Intelligence (AI) based processors, machine learning-based processors, deep learning-based processors, system-on-chip (SOC), processing circuitries including one or more modules or engines, and/or any other devices that manipulate signals and data based on computer-readable instructions, and/or any other devices.

The system 102 may be implemented, in one example, in the computing environment 100 for commissioning of the monitoring resources 108. In one example, the system 102 may enable, or at least assist in, efficient commissioning of the monitoring resources 108. In one example, the monitoring resources 108 may be commissioned to monitor conditions experienced by at least one of the transportable units 104 and the set of discrete transportable units 110, as will be discussed. The system 102 may also, in one example, enable in generation of an alert to indicate occurrence of an unintended change in the set of condition parameters, as will be discussed.

The system 102 may be implemented in multiple configurations or ways. In one example, the system 102 may be a hardware-based system including one or more hardware components or computing devices. In another example, the system 102 may be implemented as a software or an application that may be executed in the computing environment 100 for commissioning the monitoring resources 108 and monitoring the one or more conditions. In yet another example, the system 102 may be implemented as a platform that may at least assist in commissioning of the monitoring resources 108 and monitoring the one or more conditions.

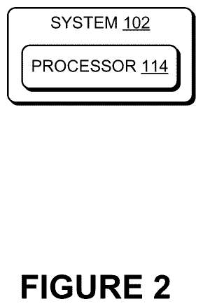

FIG. 2 illustrates a block diagram of the system 102, according to one example implementation of the present subject matter. FIG. 2 will be discussed in conjunction with FIGS. 1A and 1B. In one example, the system 102 may assist in commissioning of one or more monitoring resources 108.

In one example, the system 102 may include the processor 114 configured for commissioning of at least one monitoring resource 108 for transportable units 104. In one example, the transportable units 104 may have a hierarchical structure or arrangement. For example, as discussed above, the transportable units 104 may include the first category of transportable units and a second category of transportable units. The first category of transportable units may be the transportable units 104 and each of the second category of transportable units may be the discrete transportable unit 110 located within the first category of transportable units 104, as illustrated in FIGS. 1A and 1B. The first category and the second category may have a hierarchical relationship therebetween. For example, each of the transportable units 104 (first category) may have the set of discrete transportable units 110 (second category) associated therewith, as illustrated in FIGS. 1A and 1B. Thus, a hierarchical relationship may be there between each of the transportable units 104 and the set of discrete transportable units 110 located therein.

In one example, the processor 114 may determine the transportable unit identifier uniquely identifying each of the first category of transportable units 104, where each of the first category of transportable units 104 comprises the set of the second category of transportable units therein, the set of the second category of transportable units being the set of the discrete transportable units 110. In one example, the processor 114 may determine the transportable unit identifier in response to scanning of the machine-readable code associated with each of the first category of transportable units 104. For example, when the machine-readable code associated with a transportable unit 104 is scanned, the corresponding machine-readable representation may be determined. The machine-readable representation may be, or may be indicative of, the transportable unit identifier corresponding to that transportable unit 104. Similarly, in response to scanning of the machine-readable codes associated with each of the transportable units 104, transportable unit identifier may be determined for each of the first category of transportable unit, each transportable unit identifier uniquely identifying each of the transportable units 104.

The processor 114 may then retrieve, for each determined transportable unit identifier, a corresponding discrete unit identifier linked with the set of discrete transportable units 110 of each of the first category of transportable units 104. For example, for a transportable unit identifier, the processor 114 may retrieve a corresponding discrete unit identifier that may be linked with the set of discrete transportable units 110 located within the transportable unit 104. The discrete unit identifier may uniquely identify the set of discrete transportable units 110 located within the transportable unit 104. Similarly, for each transportable unit identifier, the processor 114 may retrieve a corresponding discrete unit identifier linked with the set of discrete transportable units 110 located within their respective transportable units 104.

In one example, the processor 114 may retrieve a discrete unit identifier based on the hierarchical relationship between the first category of transportable units 104 and the set of discrete transportable units 110. The hierarchical relationship may indicate an interlink between the transportable unit identifier, corresponding to each of the first category of transportable units 104, and the discrete unit identifier, linked with the set of discrete transportable units 110 of each of the first category of transportable units 104. In one example, the interlink may be determined based on the transportable unit identifiers and the discrete unit identifiers stored in the data storage unit 106, as will be discussed in more detail.

Further, the processor 114 may determine, for each retrieved discrete unit identifier, the set of condition parameters required to be monitored for the set of discrete transportable units 110 of each of the first category of transportable units 104. In one example, each discrete unit identifier may have associated therewith the set of condition parameters that are required to be monitored for the set of discrete transportable units 110. The set of condition parameters may include parameters, for example, that may ensure that the set of discrete transportable units maintains the desired state or characteristics that may not compromise the safety, quality, and usability of the set of discrete transportable units 110. Examples of the set of condition parameters may include, but are not limited to, temperature, pressure, and vibration levels. In one example, the processor 114 may determine the set of condition parameters required to be monitored for the set of discrete transportable units 110 based on data/information stored in the data storage unit 106, as will be discussed.

Once the set of condition parameters required to be monitored is determined, the processor 114 may identify one or more transportable units from amongst the first category of transportable units 104 having the set of discrete transportable units 110 requiring monitoring of analogous set of condition parameters. For example, the processor 114 may identify that the transportable units 104-1 and 104-3 have the set of discrete transportable units 110 which require monitoring of analogous set of condition parameters. That is, the processor 114 may identify that the set of discrete transportable units 110 located within the transportable units 104-1 and 104-3, respectively, require monitoring of analogous set of condition parameters. For example, the set of discrete transportable units 110 located within the transportable units 104-1 and 104-3, respectively, may require monitoring of temperature.

The processor 114 may then generate a cluster recommendation signal to trigger rendering of a recommendation to cluster the identified one or more transportable units 104. By generating the cluster recommendation signal, the processor 114 may cause generation of a recommendation to cluster the one or more transportable units 104 that have the set of discrete transportable units 110 which require monitoring of analogous set of condition parameters. That is, the processor 114 may recommend to cluster such transportable units 104 that have the set of discrete transportable units 110 which require monitoring of similar set of condition parameters. In one example, the recommendation may indicate the transportable unit identifier associated with each of the one or more transportable units 104 being recommended to be clustered.

Further, the processor 114 may generate a resource commissioning signal to trigger rendering of a recommendation to commission the at least one monitoring resource 108 for the identified one or more transportable units 104 being recommended to be clustered. That is, for the transportable units 104 that have the set of discrete transportable units 110 which require monitoring of analogous set of condition parameters, the processor 114 may cause generation of a recommendation to commission at least one monitoring resource 108 for the cluster of the one or more transportable units 104. The at least one monitoring resource 108 may be commissioned for monitoring the set of condition parameters for the identified one or more transportable units 104.

Thus, the processor 114 may enable in identification of transportable units 104, from amongst the plurality of transportable units 104, having the set of discrete transportable units 110 that require monitoring of the same set of condition parameters. The processor 114 may accordingly cause generation of a recommendation to group or cluster such transportable units 104. Thus, the transportable units 104 requiring monitoring of same or similar set of condition parameters may be brought together, making handling of such packages more convenient.

Further, as the same, or similar, set of condition parameters are required to be monitored, one or more monitoring resources 108 may accordingly be commissioned for the cluster of transportable units 104. Since the monitoring resources 108 may be commissioned on a per cluster basis, a reduced number of monitoring resources 108 may accordingly be required. Therefore, over-deployment of the monitoring resources 108 may be eliminated, or at least considerably reduced.

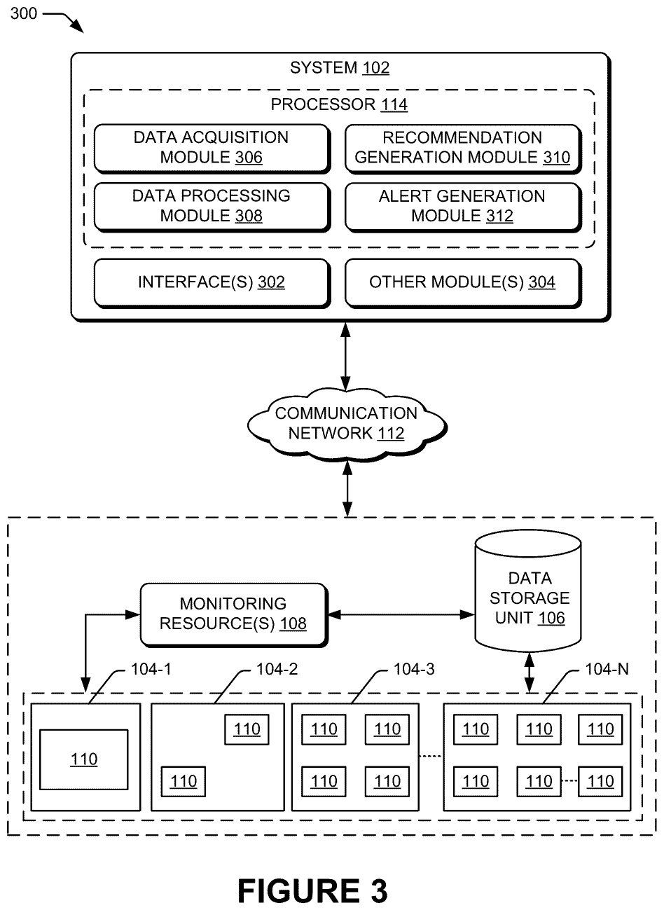

FIG. 3 illustrates a block diagram of a computing environment 300 comprising the system 102, according to another example implementation of the present subject matter. In one example, the computing environment 300 may be similar to the computing environment 100 discussed with reference to FIGS. 1A and 1B. In one example, the computing environment 300 may include the system 102, the transportable units 104 (each having the set of discrete transportable units 110, as illustrated in FIGS. 1A and 1B, and discussed above), the data storage unit 106, and the one or more monitoring resources 108. In one example, the system 102, the transportable units 104, the data storage unit 106, and the one or more monitoring resources 108 may be communicably coupled with each other over the communication network 112 to exchange data and/or signals.

As discussed above, the transportable units 104 may be entities that may be capable of receiving, storing, containing, or having attached thereto, the one or more discrete transportable units 110. Further, in one example, each of the transportable units 104 may have associated therewith the machine-readable code that may be a machine-readable representation of data, numerals, and/or characters. The machine-readable representation may indicate a transportable unit identifier that may uniquely identify the transportable unit 104 with which it may be associated. That is, the transportable unit identifier may be indicated by the machine-readable representation determined from the machine-readable code associated with the transportable unit 104. The machine-readable representation, indicating the transportable unit identifier, may indicate multiple information related to the transportable unit 104 with which it may be associated. The information may be, in one example, as per requirements of GS1 standards.

In one example, the machine-readable code may be a barcode. A machine-readable code may be associated or attached to each of the transportable units 104. For example, the machine-readable code may be printed on each of the transportable units 104 or may be attached as a tag or a label. Further, the machine-readable code may be associated with each of the transportable units 104 at any logistic stage or milestone in the supply chain. For example, the machine-readable code may be associated with each of the transportable units 104 at the time when the transportable units 104 are created or formed. In another example, the machine-readable code may be associated with each of the transportable units 104 while the transportable units 104 are filled with one or more articles or the set of discrete transportable units 110. In yet another example, the machine-readable code may be associated with each of the transportable units 104 while initiating transit or transportation of the transportable units 104. In yet another example, the machine-readable code may be associated with each of the transportable units 104 while the transportable units 104 are stored or located within any facility, such as a warehouse or inventory management facility. In one example, the machine-readable code may be printed to indicate a transportable unit identifier for a transportable unit 104 and may then be associated with it. Similarly, for each of the transportable units 104, corresponding machine-readable codes may be encoded and/or printed and associated with them. Also, the transportable unit identifier associated with each of the transportable units 104 may be stored in the data storage unit 106. That is, the data storage unit 106 may have stored therein the transportable unit identifier associated with each of the transportable units 104.

Further, each of the transportable units 104 may be associated with the set of discrete transportable units 110. For example, each of the set of discrete transportable units 110 may be placed into the transportable units 104, or may be attached to the transportable units 104. The set of discrete transportable units 110 may be associated with, or placed into, the transportable units 104 at any logistic stage or milestone in the supply chain. In one example, the transportable units 104 may be at least partially filled with the set of discrete transportable units 110 at the time of assembly.

In one example, each of the set of discrete transportable units 110 may have a machine-readable code linked therewith. In one example, the machine-readable code may be a barcode and may be linked with each of the set of discrete transportable units 110 at any logistic stage or milestone. For example, the machine-readable code may be associated with each of the set of discrete transportable units 110 by a manufacturer or assembler of the set of discrete transportable units 110 during manufacturing or packaging process.

Further, each of the set of discrete transportable units 110 may have a discrete unit identifier linked therewith. The discrete unit identifier may be obtained based on the machine-readable code linked with each of the set of discrete transportable units 110. For example, the machine-readable code may be encoded and/or printed to indicate a machine-readable representation of data, numerals, and/or characters. The machine-readable representation may indicate the discrete unit identifier that may uniquely identify the set of discrete transportable units 110. That is, the discrete transportable unit identifier may be indicated by the machine-readable representation determinable from the machine-readable code associated with the set of discrete transportable units 110.

The machine-readable representation, indicating the discrete transportable unit identifier, may be a set of numbers, alphabets, and/or characters that may indicate different information related to each of the set of discrete transportable units 110. For example, the information may include, but is not limited to, product information, Stock Keeping Unit (SKU), and Global Trade Item Number (GTIN). The product information may include, for example, the manufacturing date, expiry date, and serial number of the product (i.e., the set of discrete transportable units 110).

Further, the discrete unit identifier associated with each of the set of discrete transportable units 110 may be stored in the data repository 106. For example, during the manufacturing or packaging process, the machine-readable code may be associated with each set of the discrete transportable units 110, the machine-readable code indicating the discrete unit identifier uniquely identifying each of the set of the discrete transportable units 110. At the same logistic milestone, in one example, the machine-readable code may be scanned and saved in the data storage unit 106.

Further, an association may be created or defined between the transportable units 104 and the set of discrete transportable units 110. The association may be created or defined at any logistic milestone, such as at the time of assembly when the set of discrete transportable units 110 are being placed into the transportable units 104. The association may be, in one example, by linking the transportable unit identifiers and the discrete unit identifiers. For example, a barcode (machine-readable code) associated with a transportable unit 104 may first be scanned using any scanning device. Scanning of the barcode may cause decoding of the barcode into a machine-readable representation encoded in the barcode. Any known technique may be used to decode the barcode and obtain the machine-readable representation. The machine-readable representation may be, or may be indicative of, the transportable unit identifier associated with that transportable unit 104. Similarly, transportable unit identifiers associated with each of the transportable units 104 may be determined and stored in the data storage unit 106.

Further, at any logistic milestone, such as at the time of assembly, the set of discrete transportable units 110 may be placed into corresponding transportable units 104. For example, as illustrated in FIGS. 1A and 1B, four discrete transportable units 110, forming the set of discrete transportable units 110, may be placed into the transportable unit 104-3. Similarly, each of the transportable units 104 may include a corresponding set of discrete transportable units 110. At the time of assembly, the machine-readable code (such as the barcode) associated with each of the set of discrete transportable units 110 may be scanned. Scanning of the barcode may cause decoding of the barcode into a machine-readable representation encoded in the barcode. Any known technique may be used to decode the barcode and obtain the machine-readable representation. The machine-readable representation may be, or may be indicative of, the discrete unit identifier associated with that set of discrete transportable units 110. Similarly, discrete unit identifiers associated with each of the set of discrete transportable units 110 may be determined and stored in the data storage unit 106.

To create or define the association between the transportable units 104 and the set of discrete transportable units 110, in one example, the transportable unit identifiers and the discrete unit identifiers may be interlinked. For example, subsequent to scanning of a machine-readable code associated with a transportable unit 104, a machine-readable code associated with a set of discrete transportable units 110 may be scanned and then placed into the transportable unit 104. Such scanning may indicate that the set of discrete transportable units 110 is placed into the transportable unit 104, and may thus enable creation or definition of an interlinked relationship between the transportable unit identifier and the discrete unit identifier.

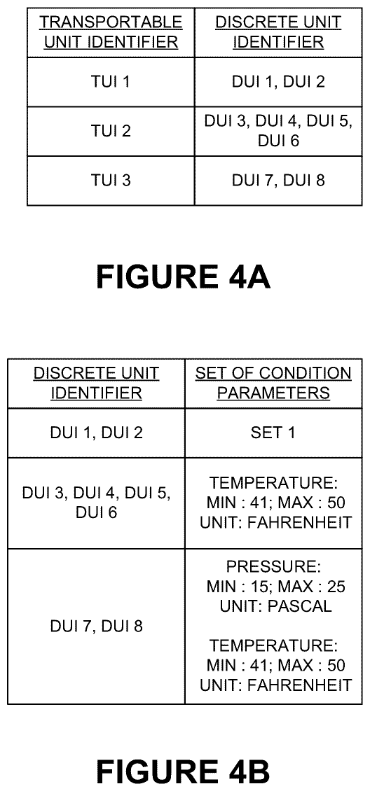

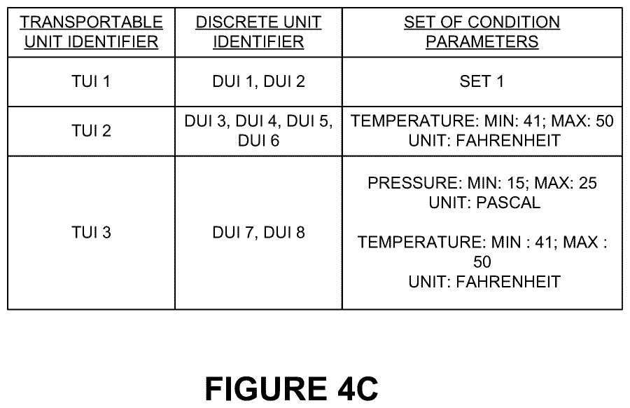

In one example, a mapping table may be formed indicating such an interlinked relationship, as illustrated in FIG. 4A. FIG. 4A illustrates the mapping indicating the interlinked relationship between the transportable unit identifier corresponding to each of the transportable units 104 and the discrete unit identifier linked with the set of discrete transportable units 110 of each of the transportable units 104, according to one example implementation of the present subject matter. FIG. 4A will be discussed in conjunction with FIG. 3.

As illustrated in FIG. 4A, a transportable unit identifier (TUI) 1 may be linked with a discrete unit identifier (DUI) 1. In one example, to create such an interlink, a machine-readable code associated with, say, transportable unit 104-1 may be scanned. The corresponding machine-readable representation and thereby the TUI 1 may be determined and stored in the mapping table. Subsequently, upon scanning of a machine-readable code associated with a set of discrete transportable units 110, corresponding machine-readable representation and thereby the DUI 1 may be determined and stored in the mapping table in relation or link with the TUI 1. Similarly, if another machine-readable code associated with another set of discrete transportable units 110 is scanned, the corresponding machine-readable representation and thereby the DUI 2 may be determined and stored in the mapping table in relation or link with the TUI 1. Such an interlink may indicate that the transportable unit 104-1, having TUI 1 associated therewith, comprises two sets of discrete transportable units 110 having DUI 1 and DUI 2 linked therewith, respectively.

Similarly, when another machine-readable code associated with, say, another transportable unit 104-2 is scanned, corresponding machine-readable representation and thereby the TUI 2 may be determined and stored in the mapping table. Subsequently, upon scanning of a machine-readable code associated with a set of discrete transportable units 110 (the set of discrete transportable units 110 may include either same or different articles as compared to the set of discrete transportable units 110 having DUI 1 and DUI 2), the corresponding machine-readable representation and thereby the DUI 3 may be determined and stored in the mapping table in relation or link with the TUI 2. Similarly, if another machine-readable code associated with another set of discrete transportable units 110 is scanned, the corresponding machine-readable representation and thereby the DUI 4 may be determined and stored in the mapping table in relation or link with the TUI 2. Similarly, DUI 5 and DUI 6 may be associated with TUI 2. Such an interlink may indicate that the transportable unit 104-2, having TUI 2 associated therewith, comprises four sets of discrete transportable units 110 having DUI 3, DUI 4, DUI 5, and DUI 6, respectively. Similarly, an interlink may be created or defined between TUI 3, DUI 7, and DUI 8, as illustrated in FIG. 4A.

In one example, the transportable unit identifier may be a Serial Shipping Container Code (SSCC) that may uniquely identify the transportable unit and the discrete unit identifier may be a Serialized Global Trade Identification Number (SGTIN) that may uniquely identify the set of discrete transportable unit. In one example, upon determining that an SSCC (i.e., TUI) has been encountered upon scanning, interlinking of SGTINs (being scanned after scanning of the SSCC) with that SSCC (like TUI 1 being linked with DUI 1 and DUI 2) may be initiated and a mapping table between SSCC and SGTINs may be obtained, similar to the mapping table indicated in FIG. 4A. In case a subsequent SSCC is encountered, it may be ascertained that subsequent SGTINs are to be linked with the subsequent SSCC (like TUI 2 being linked with DUI 3, DUI 4, DUI 5, and DUI 6). Thus, scanning of a transportable unit identifier may act as an initiation point for linking discrete unit identifiers with that transportable unit identifier.

Further, in one example, the set of discrete transportable units 110 may require monitoring of the set of condition parameters to reduce the probability of occurrence of any unintended and detrimental effect that may cause any damage, unintended change in their property or characteristic, or render them less valuable, unacceptable, or unusable. Examples of the set of condition parameters may include, but are not limited to, temperature, pressure, and vibration levels. In one example, the set of conditions parameters required to be monitored for each of the set of discrete transportable units 110 may be associated with their corresponding discrete unit identifier, as illustrated in FIG. 4B. FIG. 4B illustrates a mapping between each of the set of discrete transportable units 110 and their corresponding set of condition parameters, according to one example implementation of the present subject matter. In one example, the set of condition parameters may be defined, for each of the set of discrete transportable units 110, by an agent. Examples of the agent may include, but are not limited to, operating personnel, logistic personnel, a manufacturer, a warehouse manager, a trained device, a trained machine learning model, and a software application. As illustrated in FIG. 4B, DUI 1 and DUI 2 may have SET 1 associated therewith. SET 1 may be the set of condition parameters including at least one of temperature, pressure, vibration levels, and a combination thereof. Similarly, DUI 3, DUI 4, DUI 5, and DUI 6 may have associated therewith a minimum and maximum range of temperature required to be monitored for the set of discrete transportable units 110 having DUI 3, DUI 4, DUI 5, DUI 6 linked therewith. Similarly, DUI 7 and DUI 8 may have associated therewith a minimum and maximum range of temperature and a minimum and maximum range of pressure required to be maintained for the set of discrete transportable units 110 having DUI 7 and DUI 8 linked therewith. In one example, the mapping may be in form of a table and may be stored in the data storage unit 106.

Thus, in one example, the set of conditions parameters required to be monitored for each of the set of discrete transportable units 110 may be associated with their corresponding discrete unit identifier. In another example, the set of conditions parameters may be associated with at least a part of the discrete unit identifier. For example, the set of condition parameters required to be monitored may be associated with the SKU associated with the set of discrete transportable units 110. In this example, a mapping between the SKU and the set of condition parameters may also be formed and stored in the data storage unit 106.

Thus, a mapping may be formed between the transportable unit identifiers, discrete unit identifiers, and the set of condition parameters, as illustrated in FIG. 4C. FIG. 4C illustrates a combined mapping between the transportable unit identifiers, discrete unit identifiers, and the set of condition parameters, according to one example implementation of the present subject matter.

Further, since each of the transportable units 104 may have a set of discrete transportable units 110 associated therewith, as illustrated in FIGS. 1A and 1B, the transportable units 104 and the set of discrete transportable units 110 associated therewith may have, in one example, a hierarchical relationship therebetween. For example, the transportable units 104 may include a first category of transportable units and a second category of transportable units, where each of the second category of transportable units is the set of discrete transportable units 110 located within the first category of transportable units 104. Such a hierarchy has been exemplarily illustrated in FIGS. 1A and 1B, where each of the transportable units 104 comprises a corresponding set of discrete transportable units 110 associated therewith.

For the sake of brevity, the first category of transportable units has been interchangeably been referred to as transportable units 104, second category of transportable units has been interchangeably been referred to as discrete transportable units 110, and the set of second category of transportable units has been interchangeably been referred to as set of discrete transportable units 110.

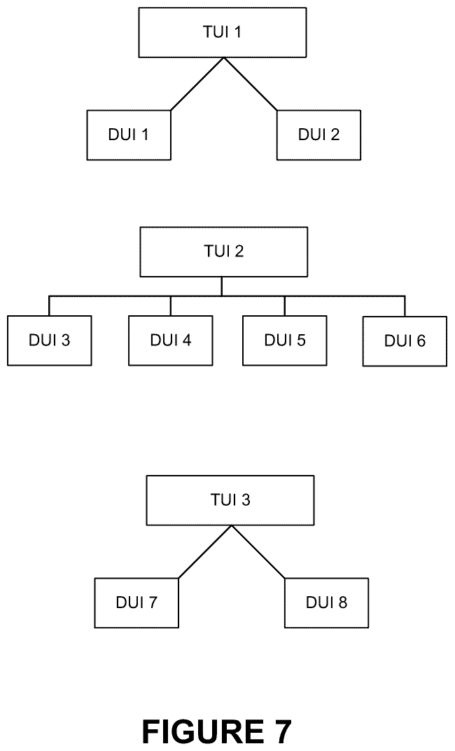

Further, in one example, each of the transportable units 104 may have a hierarchy of identifier codes. For example, the hierarchy may include a first level code and a second level code, where the first level code includes the transportable unit identifier uniquely identifying the transportable units 104, and the second level code includes the discrete unit identifier linked with the set of discrete transportable units 110. Such a hierarchy has been exemplarily illustrated in FIGS. 4A to 4C and FIG. 7, where each of the transportable unit identifiers has one or more discrete unit identifiers associated therewith. For example, TUI 1 (being the first level code) has DUI 1 and DUI 2 associated therewith (being the second level code).

The computing environment 300 may further include the system 102 that may assist in commissioning of at least one monitoring resource 108 to monitor the conditions experienced by the transportable units 104. The system 102 may include the processor 114 for commissioning at least one monitoring resource 108 for the transportable units 104. In one example, the system may further include interface(s) 302 and other module(s) 304.

The interface(s) 302 may allow the communicably coupling the system 102 with one or more other entities, such as the data storage unit 106, the monitoring resources 108, and the communication network 112. The connection or coupling may be through a wired (e.g., Local Area Network, i.e., LAN) connection or a wireless connection (e.g., Bluetooth®, Wi-Fi). The interface(s) 302 may also enable intercommunication between different logical as well as hardware components of the system 102.

The other module(s) 304 may include, in one example, a power supply unit, a communication unit, and a memory. The power supply unit may, for example, manage distribution or supply of electrical current within the system 102, for functioning of the system 102. Further, the communication unit may be, in one example, a wireless communication unit. Examples of the communication unit may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication unit may also include one or more antennas to enable wireless transmission and reception of data and signals. The communication unit may allow the system 102 to exchange data and signals with one or more other devices, such as the data storage unit 106, the monitoring resources 108, and the communication network 112.

Furthermore, the memory may be a computer-readable medium, examples of which include volatile memory (e.g., RAM), and/or non-volatile memory (e.g., Erasable Programmable read-only memory, i.e., EPROM, flash memory, etc.). The memory may be an external memory, or internal memory, such as a flash drive, a compact disk drive, an external hard disk drive, or the like.

In one example operation, the processor 114, or a data acquisition module 306 of the processor 114, may be configured to determine the transportable unit identifier uniquely identifying each of the first category of transportable units 104, where each of the first category of transportable units 104 comprises the set of the second category of transportable units therein. The set of the second category of transportable units may be the set of the discrete transportable units 110. In one example, the data acquisition module 306 of the processor 114 may determine the transportable unit identifier in response to scanning of the machine-readable code associated with each of the first category of transportable units 104. For example, when the machine-readable code associated with a transportable unit 104 is scanned, the corresponding machine-readable representation may be determined, as discussed above. The machine-readable representation may be, or may be indicative of, the transportable unit identifier corresponding to that transportable unit 104. Similarly, in response to scanning of the machine-readable codes associated with each of the transportable units 104, a transportable unit identifier may be determined by the data acquisition module 306 for each of the first category of transportable units 104, each transportable unit identifier uniquely identifying each of the transportable units 104.

In another example, the data acquisition module 306 may determine the transportable unit identifier from the data storage unit 106. For example, the data acquisition module 306, for the machine-readable code or the machine-readable representation of the machine-readable code, may access the data storage unit 106 to determine the corresponding transportable unit identifier.

The processor 114, or the data acquisition module 306, may then retrieve, for each determined transportable unit identifier, a corresponding discrete unit identifier linked with the set of discrete transportable units 110 of each of the first category of transportable units 104. For example, for a transportable unit identifier, the data acquisition module 306 may retrieve a corresponding discrete unit identifier that may be linked with the set of discrete transportable units 110 located within the transportable unit 104. For instance, for the transportable unit identifier TUI 1 associated with the transportable unit 104-1, the data acquisition module may retrieve DUI 1 and DUI 2 linked with the set of discrete transportable units 110 located within the transportable unit 104-1. In one example, the data acquisition module 306 may access the data storage unit 106 (for example, to access the mapping illustrated in FIG. 4A) to determine and retrieve the discrete unit identifier (linked with the set of discrete transportable units 110 placed in the corresponding transportable unit 104) linked with the corresponding transportable unit identifier. Similarly, the data acquisition module 306 may retrieve all the discrete unit identifiers for each of the determined transportable unit identifiers. For example, for TUI 1, the data acquisition module 306 may access the data storage unit 106 and retrieve DUI 1 and DUI 2. Similarly, for each transportable unit identifier, the processor 114 may retrieve a corresponding discrete unit identifier linked with the set of discrete transportable units 110 located within their respective transportable units 104.

Thus, the processor 114 may retrieve a discrete unit identifier based on the hierarchical relationship between the transportable units 104 and the set of discrete transportable units 110. The hierarchical relationship may indicate an interlink between the transportable unit identifier, corresponding to each of the transportable units 104, and the discrete unit identifier, linked with the set of discrete transportable units 110 of each of the transportable units 104 as illustrated in FIGS. 4A to 4C.

Further, the data acquisition module 306 may determine, for each retrieved discrete unit identifier, the set of condition parameters required to be monitored for the set of discrete transportable units 110 of each of the transportable units 104. In one example, each discrete unit identifier may have associated therewith the set of condition parameters required to be monitored for the corresponding set of discrete transportable units 110, as discussed above and illustrated in FIG. 4B. In one example, the data acquisition module 306 of the processor 114 may access the data storage unit 106 (to access the mapping as exemplarily illustrated in FIG. 4B) to determine the set of condition parameters required to be monitored for each of the retrieved discrete unit identifiers. The data acquisition module 306 may then determine the set of condition parameters, for example, based on the mapping between the DUIs and the set of condition parameters.

For example, if the retrieved discrete unit identifiers were DUI 3, DUI 4, DUI 5, and DUI 6, associated with TUI 2, the set of condition parameters may include temperature with minimum and maximum ranges as disclosed in FIG. 4C. Similarly, if the retrieved discrete unit identifiers were DUI 7 and DUI 8, associated with TUI 3, the set of condition parameters may include temperature and pressure with respective minimum and maximum ranges as disclosed in FIG. 4C. The minimum and maximum ranges may act as threshold conditions and indicate that the temperature and pressure are required to be maintained within such ranges of the set of discrete transportable units 110 with which the DUI 7 and DUI 8 are linked, which are further associated with TUI 3. In another example, the threshold conditions may be values corresponding to each condition parameter in the set of condition parameters. For example, a threshold value may be predefined for each condition parameter in the set of condition parameters. For instance, a specific threshold value may be defined for temperature and another specific value may be defined for pressure. In one example, the threshold values or threshold values may be defined by the agent. The threshold conditions and/or values may be stored in the data storage unit 106.

Further, the processor, or a data processing module 308 of the processor 114, may process data, such as the transportable unit identifiers, the discrete unit identifiers, and the set of condition parameters to identify one or more transportable units, from amongst the first category of transportable units 104, having the set of discrete transportable units 110 requiring monitoring of analogous set of condition parameters. For example, based on the data, the processor 114 may identify the set of discrete transportable units 110 that require monitoring of analogous set of parameters. As the discrete unit identifiers or the set of discrete transportable units 110 are interlinked with the transportable unit identifiers or the set of transportable units 104, respectively, for example, with the hierarchical relationship or hierarchy of the identifier codes, the processor 114 may identify the one or more transportable units 104 that are associated with the discrete unit identifiers or the set of discrete transportable units 110.

For example, the data processing module 308 may identify that the transportable units 104-2 (having TUI 2 associated therewith) and 104-3 (having TUI 3 associated therewith) have the set of discrete transportable units 110 (having DUI 3 to DUI 8 linked therewith) which require monitoring of analogous set of condition parameters. That is, the processor 114 may identify that the set of discrete transportable units 110 located within the transportable units 104-2 and 104-3, respectively, require monitoring of analogous set of condition parameters. For example, the set of discrete transportable units 110 located within the transportable units 104-2 and 104-3, respectively, require monitoring of one or more common or similar condition parameters, such as temperature (as illustrated in FIGS. 4B and 4C). Thus, the processor 114 may identify the one or more transportable units (such as the transportable units 104-2 and 104-3) having the set of discrete transportable units 110 that require monitoring of analogous set of condition parameters.

The processor 114, or a recommendation generation module 310 of the processor 114, may then generate a cluster recommendation signal to trigger rendering of a recommendation to cluster the identified one or more transportable units 104. The recommendation generation module 310 may generate a signal that may instruct generation of a recommendation to cluster the one or more transportable units 104 that have the set of discrete transportable units 110 which require monitoring of analogous set of condition parameters. That is, the recommendation generation module 310 may recommend to cluster such transportable units 104 that may probably have the set of discrete transportable units 110 which require monitoring of similar set of condition parameters.

In one example, the recommendation may indicate the transportable unit identifier associated with each of the one or more transportable units 104 being recommended to be clustered. For example, the recommendation may cause rendering of TUI 2 and TUI 3 to indicate that the transportable units 104 having TUI 2 and TUI 3 associated therewith may be clustered or grouped. In one example, the signal may cause rendering of the recommendation on a device associated with the agent. The device may include a display and may be communicably coupled with the system, or at least the processor 114, through the communication network 112. In one example, the device may be remotely located from the system 102. In one example, the signal may cause rendering of a table indicating at least the transportable unit identifiers that are being recommended to be clustered. For example, the signal may cause rendering of a table indicating that TUI 2 and TUI 3 (associated with the transportable units 104-2 and 104-3) are being recommended to be clustered, as analogous set of parameters are required to be monitored for the set of discrete transportable units 110 located therein.

In one example, the identified one or more transportable units 104 may include the set of discrete transportable units 110 having similar characteristics and requiring monitoring of analogous set of parameters. Examples of characteristics may include, but are not limited to, solid, liquid, gas, geometry, and weight. In another example, the identified one or more transportable units 104 may include the set of discrete transportable units 110 having distinct characteristics and requiring monitoring of analogous set of parameters. Thus, even if the identified set of transportable units 104 has the set of discrete transportable units 110 with different characteristics, they may be recommended to be clustered, since they require monitoring of similar set of condition parameters. Thus, the transportable units 104 may be clustered irrespective of their characteristics if they require monitoring of similar set of condition parameters. As a result, clustering flexibility may be increased and more number of transportable units 104 can be clustered.

Further, the processor 114, or the recommendation generation module 310, may generate another signal, being referred to as the resource commissioning signal, to trigger rendering of a recommendation to commission the at least one monitoring resource 108 for the identified one or more transportable units 104 being recommended to be clustered. That is, for the transportable units 104 that have the set of discrete transportable units 110 which require monitoring of analogous set of condition parameters, the recommendation generation module 310 may cause rendering of a recommendation to commission at least one monitoring resource 108 for the cluster of the one or more transportable units 104. The at least one monitoring resource 108 may be commissioned for monitoring the set of condition parameters for the identified one or more transportable units 104. For example, the signal may cause or instruct the device associated with the agent to render a recommendation indicating the at least one monitoring resource 108 to be commissioned for the cluster of transportable units 104-2 and 104-3 as they require monitoring of analogous set of condition parameters.

In one example, the resource commissioning signal may also trigger rendering of a resource information indicating at least one property associated with the at least one monitoring resource 108 to be commissioned for monitoring the set of condition parameters for the identified one or more transportable units 104. In one example, the at least one property may be a name or type of sensor being recommended to be commissioned. In one example, the property may be determined by the processor 114 based on the set of condition parameters required to be monitored. For example, the data storage unit 106 may store a mapping between condition parameters, in the set of condition parameters, and a corresponding sensor recommended to be commissioned. For example, to monitor temperature, the mapping may indicate a temperate sensor to be commissioned. Thus, at least one monitoring resource 108 may be commissioned for the cluster of transportable units 104.

Therefore, the processor 114, in one example, may enable identification of transportable units 104, from amongst the plurality of transportable units 104, having the set of discrete transportable units 110 that require monitoring of the same set of condition parameters. The processor 114 may accordingly cause generation of a recommendation to group or cluster such transportable units 104. Further, the at least one monitoring resource 108 may accordingly be commissioned for the cluster of transportable units 104. Over-deployment of the monitoring resources 108 may be considerably reduced.

Further, in one example, the processor 114, or the data processing module 308, may receive resource data from the at least one monitoring resource 108. In one example, the processor 114, subsequent to the commissioning of the at least one monitoring resource 108 and being communicably coupled with the monitoring resource 108, may receive the resource data. The resource data may be received, continuously, at regular intervals, or at intervals as defined by the agent.

The resource data may indicate a value for each condition parameter in the set of condition parameters being monitored by the at least one monitoring resource 108. For example, if the at least one monitoring resource 108 was commissioned for the transportable units 104-2 and 104-3, the resource data may indicate a value indicating a temperature experienced, or being experienced in real-time, by the transportable units 104-2 and 104-3 or the set of discrete transportable units 110 placed or located therein. For instance, the resource data may indicate a value corresponding to temperature, say, 57 degrees Fahrenheit (F).

The processor 114, or the data processing module 308, may then compare the value corresponding to each condition parameter in the set of condition parameters with a threshold value corresponding to each condition parameter in the set of condition parameters. For example, the data processing module 308 may access the threshold value for temperature from the data storage unit 106, as illustrated in FIGS. 4B and 4C. As illustrated in FIGS. 4B and 4C, the threshold value for temperature is a range of 41 to 50 degrees F. The data processing module 308 may compare the value corresponding to temperature with the threshold value or range.

Based on the comparison, the processor 114, or the data processing module 308, may ascertain whether to trigger an alert. For example, if the data processing module 308 determines that the value indicated by the resource data is either less than the threshold value or with the threshold range, the data processing module 308 may ascertain not to trigger the alert. However, if data processing module 308 determines that the value indicated by the resource data is either equal to or greater than the threshold value or beyond the threshold range, the data processing module 308 may ascertain to trigger the alert.

In one example, the processor, or an alert generation module 312, may trigger the alert to indicate occurrence of an unintended change in the set of condition parameters. For instance, considering the above example of 57 degrees F., the alert generation module 312 may trigger the alert to indicate that the temperature experienced, or being experienced in real-time, has crossed the defined threshold value or condition.

In one example, the alert may include at least one of an audio alert, a visual alert, and a combination thereof. The alert may indicate the condition parameter, for example, the temperature, that may have caused triggering of the alert. In one example, the processor 114 or the alert generation module 312 may cause rendering of the alert on the device associated with the agent.

Further, in one example, the threshold value, corresponding to each condition parameter in the set of condition parameters, may be modifiable. For example, the threshold values may be modifiable to configure the triggering of the alerts. In one example, the processor 114 may be capable of receiving instructions to modify the threshold values through the device associated with the agent. Modification of the threshold values may provide flexibility to define the threshold values as per situation and requirements, for example, of the set of discrete transportable units 110 or the environment they may be located in.

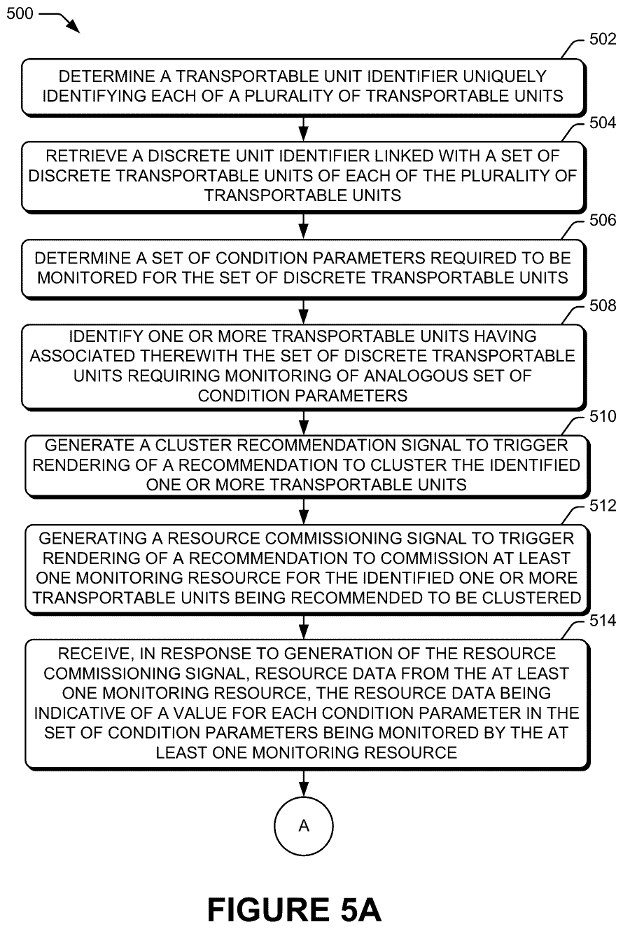

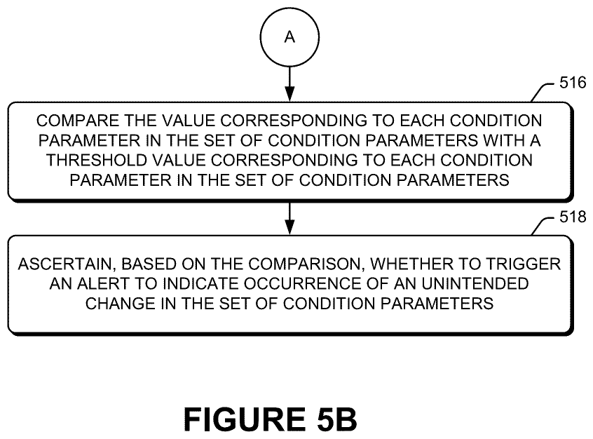

FIGS. 5A and 5B illustrate an exemplary method 500 for the commissioning of monitoring resources and generation of an alert, according to one example implementation of the present subject matter. The order in which the method is described is not intended to be construed as a limitation, and any number of the described method blocks may be combined in any order to implement the method 500, or an alternative method. Furthermore, method 500 may be implemented by processing resource or computing device(s) through any suitable hardware, non-transitory machine-readable instructions, or combination thereof.

It may also be understood that method 500 may be performed by programmed computing devices, such as the processor 114, as depicted in FIGS. 1A-1B, 2, and 3. Furthermore, the method 500 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 500 is described below with reference to the processor 114 and the system 102 as described above; other suitable systems for the execution of these methods may also be utilized. Additionally, the implementation of these methods is not limited to such examples.

At block 502, a transportable unit identifier uniquely identifying each of a plurality of transportable units may be determined. In one example, the transportable unit identifier may be determined in response to scanning of a machine-readable code associated with each of the plurality of transportable units, such as the transportable units 104. Each of the transportable units may have a corresponding uniquely identifying transportable unit identifier associated therewith. In one example, each of the transportable unit identifiers may be stored in a data storage unit, such as the data storage unit 106. Further, each of the transportable units may have a set of discrete transportable units, such as the set of discrete transportable units 110, associated therewith.

At block 504, a discrete unit identifier linked with the set of discrete transportable units of each of the plurality of transportable units may be retrieved for each transportable unit identifier. In one example, each set of discrete transportable units may have a corresponding discrete unit identifier linked therewith. The discrete unit identifier uniquely identifies the set of discrete transportable units. In one example, the data storage unit may include a mapping that indicates an interlinked relationship between the transportable unit identifiers and the discrete unit identifiers, as discussed above and illustrated in FIG. 4A. The retrieving may thus be based on the interlinked relationship between the transportable unit identifier associated with each of the plurality of transportable units and the discrete unit identifier linked with the set of discrete transportable units of each of the plurality of transportable units.

At block 506, a set of condition parameters required to be monitored for the set of discrete transportable units may be determined for each retrieved discrete unit identifier. In one example, the set of condition parameters may be determined based on a mapping between each of the discrete unit identifiers and the set of condition parameters, as discussed above and illustrated in FIG. 4B. The set of condition parameters may indicate one or more conditions required to be monitored for the set of discrete transportable units that are linked with each of the retrieved discrete unit identifiers.

At block 508, one or more transportable units may be determined that have associated therewith the set of discrete transportable units requiring monitoring of analogous set of condition parameters. In one example, based on the analogous set of condition parameters associated with the discrete unit identifiers, one or more transportable unit identifiers linked with such discrete unit identifiers may be identified. Based on the one or more transportable unit identifiers, the one or more transportable units corresponding to those one or more transportable unit identifiers may be identified. The identified one or more transportable units may have the set of discrete transportable units that require monitoring of analogous set of condition parameters.

At block 510, a cluster recommendation signal may be generated to trigger rendering of a recommendation to cluster the identified one or more transportable units. In one example, the signal that may instruct generation of a recommendation to cluster the one or more transportable units that have the set of discrete transportable units that require monitoring of analogous set of condition parameters. That is, a recommendation may be triggered to cluster such transportable units that may probably have the set of discrete transportable units that require monitoring of same set of condition parameters. In one example, the recommendation may indicate the transportable unit identifier associated with each of the identified one or more transportable units being recommended to be clustered.

In one example, the identified one or more transportable units may include the set of discrete transportable units having similar characteristics and requiring monitoring of analogous set of parameters. In another example, the identified one or more transportable units may include the set of discrete transportable units having distinct characteristics and requiring monitoring of analogous set of parameters. Thus, even if the identified set of transportable units has the set of discrete transportable units with different characteristics, they may be recommended to be clustered, since they require monitoring of similar set of condition parameters.

At block 512, a resource commissioning signal may be generated to trigger rendering of a recommendation to commission at least one monitoring resource for the identified one or more transportable units being recommended to be clustered. The at least one monitoring resource may monitor the set of condition parameters for the identified one or more transportable units. In one example, for the identified one or more transportable units that have the set of discrete transportable units that require monitoring of analogous set of condition parameters, the resource commissioning signal may cause rendering of the recommendation to commission at least one monitoring resource for the cluster of the one or more transportable units. Thus, the at least one monitoring resource may be commissioned for the cluster of transportable units to monitor the set of condition parameters.

At block 514, resource data from the at least one monitoring resource may be received in response to generation of the resource commissioning signal. The resource data may be indicative of a value for each condition parameter in the set of condition parameters being monitored by the at least one monitoring resource. In one example, subsequent to the commissioning of the at least one monitoring resource, the resource data may be received. The resource data may indicate a value for each condition parameter in the set of condition parameters being monitored by the at least one monitoring resource. For example, the resource data may indicate a value indicating pressure experienced, or being experienced in real-time, by the identified one or more transportable units or the set of discrete transportable units placed or located therein. For instance, the resource data may indicate a value corresponding to pressure, say, 33 pascal (Pa). The method may then flow to block A.

From block A and at block 516, the value corresponding to each condition parameter in the set of condition parameters may be compared with a threshold value corresponding to each condition parameter in the set of condition parameters. In one example, once the resource data has been received, the value indicated for each condition parameter in the set of condition parameters may be compared with a threshold value corresponding to each condition parameter in the set of condition parameters. In one example, the threshold value for pressure may be obtained from the data storage unit. As illustrated in FIGS. 4B and 4C, the threshold value for pressure may be a range of 15 to 25 Pa. The value corresponding to pressure, indicated by the resource data, may be compared with the threshold value or range.

At block 518, it may be ascertained whether an alert is to be triggered to indicate occurrence of an unintended change in the set of condition parameters. In one example, based on the comparison, it may ascertain whether to trigger an alert. For example, if the pressure value indicated by the resource data is either less than the threshold value or within the threshold range, it may be ascertained that the alert is not to be triggered, and the method may continue from the block 514.

However, if the value indicated by the resource data is either equal to or greater than the threshold value or beyond the threshold range, it may be ascertained that the alert is to be triggered. In one example, the alert may include at least one of an audio alert, a visual alert, and a combination thereof. The alert may indicate the condition parameter, for example, the pressure, that may have caused triggering of the alert.

Further, in one example, the threshold value, corresponding to each condition parameter in the set of condition parameters, may be modifiable. For example, the threshold values may be modifiable to dynamically update conditions that trigger the alerts. That is, modification of the threshold values may provide flexibility to update the threshold values as per situation and/or requirements.

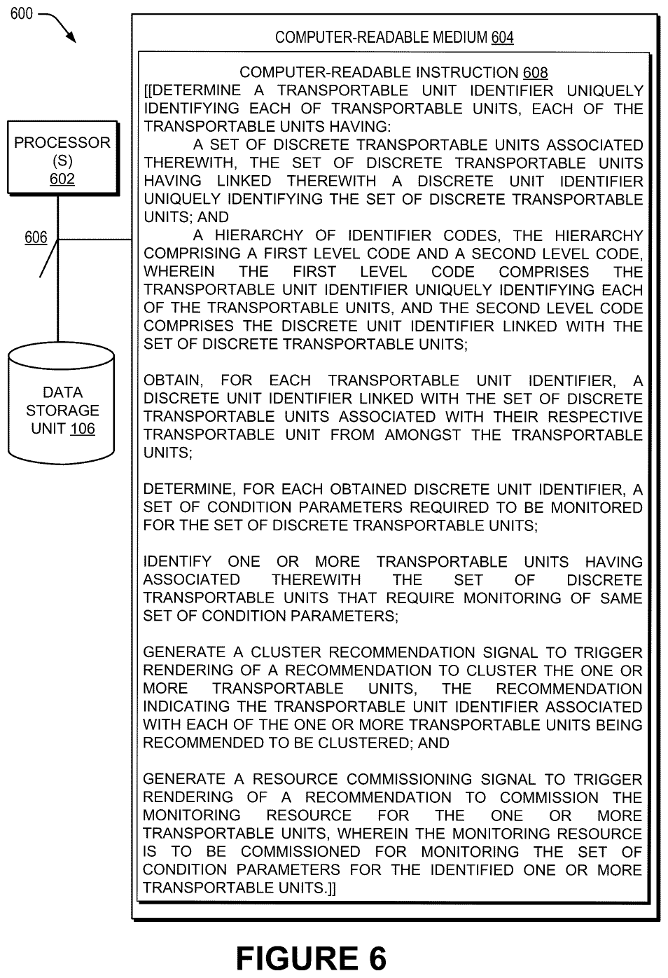

FIG. 6 illustrates a non-transitory computer-readable medium for commissioning a monitoring resource for transportable units, in accordance with an example of the present subject matter.

In an example, the computing environment 600 includes a processor 602 communicatively coupled to a non-transitory computer-readable medium 604 through communication link 606. In one example, the processor 602 may have one or more processing resources for fetching and executing computer-readable instructions from the non-transitory computer-readable medium 604. The processor 602 and the non-transitory computer-readable medium 604 may be implemented, for example, in the system 102.

The non-transitory computer-readable medium 604 may be, for example, an internal memory device or an external memory. In an example implementation, the communication link 606 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer-readable medium 604 includes a set of computer-readable instructions 608 which may be accessed by the processor 602 through the communication link 606. The processor 602 and the non-transitory computer-readable medium 604 may also be communicatively coupled to the data storage unit 106 over the communication link 606.

Referring to FIG. 6, in an example, the non-transitory computer-readable medium 604 includes computer-readable instructions 608 that may cause the processor 602 to determine a transportable unit identifier uniquely identifying each of the transportable units, such as the transportable units 104. In one example, the transportable unit identifier uniquely identifying each of the transportable units 104 may be determined in response to scanning of a machine-readable code associated with each of the transportable units 104, as discussed above. In one example, each of the transportable unit identifiers may be stored in the data storage unit 106 and may be determined by accessing the data storage unit 106.

Further, each of the plurality of transportable units 104 may have a set of discrete transportable units, such as the set of discrete transportable units 110 associated therewith, as discussed above and in FIGS. 1A and 1B, and FIG. 3. Each of the set of discrete transportable units 110 may have the discrete unit identifier linked therewith and uniquely identifying the set of discrete transportable units 110.

Furthermore, each of the plurality of transportable units 104 may have a hierarchy of identifier codes. The hierarchy may include the first level code and the second level code. In one example, the first level code may include the transportable unit identifier uniquely identifying each of the transportable units 104, and the second level code may include the discrete unit identifier linked with each of the set of discrete transportable units 110. The hierarchy of codes, as discussed above with reference to FIG. 3, has also been illustrated in FIG. 7. FIG. 7 illustrates the hierarchy of identifier codes, according to one example implementation of the present subject matter. FIG. 7 will be discussed in conjunction with FIG. 6. As illustrated in FIG. 1, TUI 1 (being the transportable unit identifier associated with, say, the transportable unit 104-1) may be the first level code. DUI 1 and DUI 2 (each being a discrete unit identifier being associated with, say, a corresponding set of the discrete transportable units 110) may be the second level code. The hierarchy may thus indicate an interlinked relationship between each of the transportable unit identifiers and each of the discrete unit identifiers. For example, the hierarchy may indicate each of the transportable unit identifiers having one or more discrete unit identifiers that may be associated therewith. For example, TUI 1 (being the first level code) has DUI 1 and DUI 2 associated therewith (being the second level code). Similarly, other exemplary hierarchies have been illustrated in FIG. 7.

The instructions 608 may further cause the processor 602 to obtain, for each transportable unit identifier, the discrete unit identifier linked with the set of discrete transportable units 110 associated with their respective transportable unit from amongst the transportable units 104. In one example, each transportable unit identifier may have a discrete unit identifier linked therewith, as also illustrated in FIG. 7. Further, each discrete unit identifier may also be linked with the set of discrete transportable units 110, the set of discrete transportable units 110 being further associated with their respective transportable unit from amongst the transportable units 104, as discussed above. Thus, for each transportable unit identifier, the processor 602 may obtain a discrete unit identifier. The discrete unit identifier uniquely identifies the set of discrete transportable units 110. In one example, the data storage unit 106 may include a mapping that indicates an interlinked relationship between the transportable unit identifiers and the discrete unit identifiers, as discussed above and illustrated in FIG. 4A. The processor 602 may obtain the discrete unit identifier, for each transportable unit identifier, by accessing the mapping from the data storage unit 106.

The instructions 608 may further cause the processor 602 to determine, for each obtained discrete unit identifier, a set of condition parameters required to be monitored for the set of discrete transportable units 110. In one example, the set of condition parameters may be determined by the processor 602 based on a mapping between each of the discrete unit identifiers and the set of condition parameters, as discussed above and illustrated in FIG. 4B. The set of condition parameters may indicate one or more conditions required to be monitored for the set of discrete transportable units that are linked with each of the retrieved discrete unit identifiers. The set of condition parameters may include, for example, at least one of temperature, pressure, vibration levels, and a combination thereof.

The instructions 608 may further cause the processor 602 to identify one or more transportable units, from amongst the transportable units 104, having associated therewith the set of discrete transportable units 110 that require monitoring of same set of condition parameters. In one example, based on the similarity of set of condition parameters associated with the discrete unit identifiers, the one or more transportable unit identifiers linked with such discrete unit identifiers may be identified by the processor 602. In one example, the linkage may be identifiable based on the hierarchy of identifier codes, as illustrated in FIG. 7. Based on the one or more transportable unit identifiers, the one or more transportable units corresponding to those one or more transportable unit identifiers may be identified. The identified one or more transportable units may have the set of discrete transportable units that require monitoring of the same set of condition parameters.

The instructions 608 may further cause the processor 602 to generate a cluster recommendation signal to trigger rendering of a recommendation to cluster the identified one or more transportable units. In one example, by generating the cluster recommendation signal, the processor 602 may trigger rendering of the recommendation to cluster such transportable units that have the set of discrete transportable units 110 which require monitoring of the same set of condition parameters. In one example, the recommendation may indicate the transportable unit identifier associated with each of the identified one or more transportable units being recommended to be clustered. By rendering the transportable unit identifier, it may be convenient and less time consuming, for example for the agent, to identify the transportable units required to be clustered, from amongst a large number of transportable units 104.

The instructions 608 may further cause the processor 602 to generate a resource commissioning signal to trigger rendering of a recommendation to commission a monitoring resource, such as the monitoring resource 108 for the identified one or more transportable units being recommended to be clustered. The monitoring resource may monitor the set of condition parameters for the identified one or more transportable units. Thus, the monitoring resource 108 may be commissioned or deployed for the cluster of transportable units to monitor the set of condition parameters.

In one example, the resource commissioning signal may also trigger rendering of the resource information indicating at least one property associated with the monitoring resource 108 to be commissioned for monitoring the set of condition parameters for the identified one or more transportable units 104. In one example, the at least one property may be a name or type of one or more sensor units being recommended to be commissioned. In one example, the property may be determined by the processor 602 based on the set of condition parameters required to be monitored. For example, the data storage unit 106 may store a mapping between condition parameters, in the set of condition parameters, and a corresponding sensor unit recommended to be commissioned. For example, to monitor humidity, the mapping may indicate a humidity sensor to be commissioned.

The instructions 608 may further cause the processor 602 to receive, in response to generation of the resource commissioning signal, resource data from the monitoring resource 108. The resource data may be indicative of a value for each condition parameter in the set of condition parameters being monitored by the monitoring resource 108. For example, the resource data may indicate a value indicating humidity experienced, or being experienced in real-time, by the identified one or more transportable units 104 or the set of discrete transportable units 110 placed or located therein. For instance, the resource data may indicate a value corresponding to pressure, say, 10 gram per cubic meter.

The instructions 608 may further cause the processor 602 to compare the value corresponding to each condition parameter in the set of condition parameters with a threshold value corresponding to each condition parameter in the set of condition parameters. In one example, the threshold value for humidity may be stored in the data storage unit 106. The value corresponding to humidity, indicated by the resource data, may be compared with the threshold value or range defined for humidity.

The instructions 608 may further cause the processor 602 to ascertain whether an alert is to be triggered to indicate occurrence of an unintended change in the set of condition parameters. The processor 602 may ascertain, based on the comparison, whether to trigger the alert. For example, if the humidity value indicated by the resource data is either less than the threshold value or within the threshold range defined for humidity (and stored in the data storage unit 106), the processor 602 may ascertain that the alert is not required to be triggered.

On the other hand, if the humidity value indicated by the resource data is either equal to or greater than the threshold value or beyond the threshold range defined for humidity, the processor 602 may ascertain that the alert is required to be triggered. The alert may indicate the condition parameter, for example, the pressure, that may have caused triggering of the alert. In one example, the alert may include at least one of an audio alert, a visual alert, and a combination thereof.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A method comprising:
determining, in response to scanning of a machine-readable code associated with each of a plurality of transportable units, a transportable unit identifier uniquely identifying each of the plurality of transportable units, each of the plurality of transportable units having a set of discrete transportable units associated therewith;
retrieving, for each transportable unit identifier, a discrete unit identifier linked with the set of discrete transportable units of each of the plurality of transportable units, the discrete unit identifier uniquely identifying the set of discrete transportable units, wherein the retrieving is based on an interlinked relationship between the transportable unit identifier associated with each of the plurality of transportable units and the discrete unit identifier linked with the set of discrete transportable units of each of the plurality of transportable units;
determining, for each retrieved discrete unit identifier, a set of condition parameters required to be monitored for the set of discrete transportable units;
identifying one or more transportable units, from amongst the plurality of transportable units, having associated therewith the set of discrete transportable units requiring monitoring of analogous set of condition parameters;
generating a cluster recommendation signal to trigger rendering of a recommendation to cluster the identified one or more transportable units, the recommendation indicating the transportable unit identifier associated with each of the one or more transportable units being recommended to be clustered; and
generating a resource commissioning signal to trigger rendering of a recommendation to commission at least one monitoring resource for the identified one or more transportable units being recommended to be clustered, wherein the at least one monitoring resource is to monitor the set of condition parameters for the identified one or more transportable units.

2. The method of claim 1, the method further comprising:
receiving, in response to generation of the resource commissioning signal, resource data from the at least one monitoring resource, the resource data being indicative of a value for each condition parameter in the set of condition parameters being monitored by the at least one monitoring resource;
comparing the value corresponding to each condition parameter in the set of condition parameters with a threshold value corresponding to each condition parameter in the set of condition parameters; and
ascertaining, based on the comparison, whether to trigger an alert to indicate occurrence of an unintended change in the set of condition parameters.

3. The method of claim 2, wherein the alert comprises at least one of an audio alert, a visual alert, and a combination thereof.

4. The method of claim 2, wherein the threshold value, corresponding to each condition parameter in the set of condition parameters, is modifiable.

5. The method of claim 1, wherein the identified one or more transportable units comprises the set of discrete transportable units having similar characteristics and requiring monitoring of analogous set of parameters.

6. The method of claim 1, wherein the identified one or more transportable units comprises the set of discrete transportable units having distinct characteristics and requiring monitoring of analogous set of parameters.

7. A system comprising:
a processor for commissioning at least one monitoring resource for transportable units, the transportable units comprising a first category of transportable units and a second category of transportable units, each of the second category of transportable units being a discrete transportable unit located within the first category of transportable units, wherein the first category and the second category have a hierarchical relationship therebetween, wherein the processor is to:
determine, in response to scanning of a machine-readable code associated with each of the first category of transportable units, a transportable unit identifier uniquely identifying each of the first category of transportable units, wherein each of the first category of transportable units comprises a set of the second category of transportable units therein, the set of the second category of transportable units being a set of the discrete transportable units,
retrieve, for each transportable unit identifier, a discrete unit identifier linked with the set of discrete transportable units of each of the first category of transportable units, the discrete unit identifier uniquely identifying the set of discrete transportable units, wherein the processor is to retrieve based on the hierarchical relationship between the first category of transportable units and the set of discrete transportable units, the hierarchical relationship being indicative of an interlink between the transportable unit identifier corresponding to each of the first category of transportable units and the discrete unit identifier linked with the set of discrete transportable units of each of the first category of transportable units;
determine, for each retrieved discrete unit identifier, a set of condition parameters required to be monitored for the set of discrete transportable units of each of the first category of transportable units;
identify one or more transportable units, from amongst the first category of transportable units, having the set of discrete transportable units requiring monitoring of analogous set of condition parameters;
generate a cluster recommendation signal to trigger rendering of a recommendation to cluster the identified one or more transportable units, the recommendation indicating the transportable unit identifier associated with each of the identified one or more transportable units being recommended to be clustered; and
generate a resource commissioning signal to trigger rendering of a recommendation to commission the at least one monitoring resource for the identified one or more transportable units being recommended to be clustered, wherein the at least one monitoring resource is to be commissioned for monitoring the set of condition parameters for the identified one or more transportable units.

8. The system of claim 7, the system further comprising a data storage unit communicably coupled with the processor, wherein the data storage unit is to store:
the transportable unit identifier uniquely identifying each of the first category of transportable units;
the discrete unit identifier uniquely identifying the set of discrete transportable units of each of the first category of transportable units;
the set of condition parameters required to be monitored for the set of discrete transportable units of each of the first category of transportable units; and
a mapping indicating the interlink between the transportable unit identifier corresponding to each of the first category of transportable units and the discrete unit identifier linked with the set of discrete transportable units of each of the first category of transportable units.

9. The system of claim 7, wherein the hierarchical relationship between the first category of transportable units and the set of discrete transportable units is defined at a logistic milestone in a supply chain associated with the transportable units, wherein the logistic milestone comprises a set of stages where:
the machine-readable code is associated with each of the first category of transportable units, the machine-readable code being indicative of the transportable unit identifier uniquely identifying each of the first category of transportable units;
each set of discrete transportable units is linked with the discrete unit identifier uniquely identifying each set of discrete transportable units;
the set of discrete transportable units is placed into a transportable unit of the first category; and
the discrete unit identifier, associated with each set of discrete transportable units, is linked with the transportable unit identifier associated with the transportable unit in which the set of discrete transportable units is placed.

10. The system of claim 7, wherein the processor is to:
receive, in response to generation of the resource commissioning signal, resource data from the at least one monitoring resource, the resource data being indicative of a value for each condition parameter in the set of condition parameters being monitored by the at least one monitoring resource;
compare the value corresponding to each condition parameter in the set of condition parameters with a threshold value corresponding to each condition parameter in the set of condition parameters; and
ascertain, based on the comparison, whether to trigger an alert to indicate occurrence of an unintended change in the set of condition parameters.

11. The system of claim 10, wherein the alert comprises at least one of an audio alert, a visual alert, and a combination thereof.

12. The system of claim 10, wherein the threshold value, corresponding to each condition parameter in the set of condition parameters, is modifiable.

13. The system of claim 7, wherein the identified one or more transportable units comprises one of:
the set of discrete transportable units having similar characteristics and requiring monitoring of analogous set of parameters; and
the set of discrete transportable units having distinct characteristics and requiring monitoring of analogous set of parameters.

14. The system of claim 7, wherein the machine-readable code comprises a barcode associated with each of the first category of transportable units.

15. The system of claim 7, wherein the resource commissioning signal is to further trigger rendering of a resource information indicating at least one property associated with the at least one monitoring resource to be commissioned for monitoring the set of condition parameters for the identified one or more transportable units.

16. The system of claim 7, wherein the set of condition parameters comprises at least one of temperature, pressure, vibration levels, and a combination thereof.

17. A non-transitory computer-readable medium comprising instructions being executable by a processing resource for commissioning a monitoring resource for transportation units, wherein the processing resource is to:
determine, in response to scanning of a machine-readable code associated with each of the transportable units, a transportable unit identifier uniquely identifying each of the transportable units, each of the transportable units having:
a set of discrete transportable units associated therewith, the set of discrete transportable units having linked therewith a discrete unit identifier uniquely identifying the set of discrete transportable units; and
a hierarchy of identifier codes, the hierarchy comprising a first level code and a second level code, wherein the first level code comprises the transportable unit identifier uniquely identifying each of the transportable units, and the second level code comprises the discrete unit identifier linked with the set of discrete transportable units;
obtain, for each transportable unit identifier, a discrete unit identifier linked with the set of discrete transportable units associated with their respective transportable unit from amongst the transportable units;
determine, for each obtained discrete unit identifier, a set of condition parameters required to be monitored for the set of discrete transportable units;
identify one or more transportable units, from amongst the transportable units, having associated therewith the set of discrete transportable units that require monitoring of same set of condition parameters;
generate a cluster recommendation signal to trigger rendering of a recommendation to cluster the identified one or more transportable units, the recommendation indicating the transportable unit identifier associated with each of the identified one or more transportable units being recommended to be clustered; and
generate a resource commissioning signal to trigger rendering of a recommendation to commission the monitoring resource for the identified one or more transportable units, wherein the monitoring resource is to be commissioned for monitoring the set of condition parameters for the identified one or more transportable units.

18. The non-transitory computer-readable medium of claim 17, wherein the resource commissioning signal is to further trigger rendering of a resource information indicating at least one property associated with the monitoring resource to be commissioned for monitoring the set of condition parameters for the identified one or more transportable units.

19. The non-transitory computer-readable medium of claim 17, wherein the processing resource is to:
receive, in response to generation of the resource commissioning signal, resource data from the monitoring resource, the resource data being indicative of a value for each condition parameter in the set of condition parameters being monitored by the monitoring resource;
compare the value corresponding to each condition parameter in the set of condition parameters with a threshold value corresponding to each condition parameter in the set of condition parameters; and
ascertain, based on the comparison, whether to trigger an alert to indicate a change in the set of condition parameters.

20. The non-transitory computer-readable medium of claim 17, wherein the set of condition parameters comprises at least one of temperature, pressure, vibration levels, and a combination thereof.
